(19) United States
(12) Patent Application Publication
(10) Pub. No.: US 2021/0357934 A1
(43) Pub. Date: Nov. 18, 2021

(54) DIGITAL CONTENT SUBSCRIPTION MANAGEMENT VIA OPTICAL CODES

(71) Applicant: T-Mobile USA, Inc., Bellevue, WA (US)

(72) Inventor: Syam Kunjukrishnan, Sammamish, WA (US)

(21) Appl. No.: 16/876,939

(22) Filed: May 18, 2020

(51) Int. Cl. G06Q 20/40; G06K 7/14; G06Q 20/14; H04L 29/06

(52) U.S. Cl. CPC G06Q 20/401; H04L 63/08; G06Q 20/14; G06K 7/1417

(57) ABSTRACT

Techniques are described herein for managing digital content subscription. The techniques include transmitting a request to access premium content from a playback device logged into a user account for a streaming service. The user device receives an optical code generated by the playback device. The user device is associated with a subscriber account for telecommunication services, which include the streaming service. The techniques also include deciphering the optical code to access a payment portal and logging into the payment portal using credentials associated with the subscriber account, wherein the subscriber account is associated with the user account. Payment is submitted for the premium content using billing information associated with the subscriber account via the payment portal and the premium content may be accessed via the user account.

### BACKGROUND

Various types of digital content and programs such as movies, television shows, news programs, and sporting events are available via streaming services and viewed on a television or other consumer playback devices. Typically, a streaming service offers subscriptions to access these digital content and programs. Some of the standard content and programs may be included in a subscription plan or offered for free if viewed with commercials and advertisements presented in between content segments.

A subscriber may, however, wish to access certain content (i.e., premium content) and programs or view these content and programs without commercials and advertisements. In such situations, the subscriber may upgrade the subscription or pay a one-time fee to access the premium content. This may require the subscriber to request assistance from a customer service representative, log in to the subscriber's account to manually upgrade the subscription plan on a separate user device, and/or access a payment portal to access billing information and pay the one-time fee. Doing so can take away the usability of the streaming service and provide a negative user experience.

### BRIEF DESCRIPTION OF THE DRAWINGS

The detailed description is described with reference to the accompanying figures, in which the leftmost digit(s) of a reference number identifies the figure in which the reference number first appears. The use of the same reference numbers in different figures indicates similar or identical items.

FIG. 1 illustrates an example network architecture for managing digital content subscription from a streaming service provider through a mobile network operator (MNO).

FIG. 2 is a block diagram showing various components of an illustrative computing device such as a user device that requests digital content and submits payment through a payment portal.

FIG. 3 is a block diagram showing various components of an illustrative computing device such as a playback device that presents digital content from a content provider.

FIG. 3 is a block diagram showing various components of an illustrative computing device such as an application server for providing account management functionalities.

FIG. 5 is a flow diagram of an example process for requesting digital content and transmitting payment to receive access to the digital content.

FIG. 6 is a flow diagram of an example process for associating a user account for a streaming service and a subscriber account for a telecommunication service.

### DETAILED DESCRIPTION

This disclosure is directed to techniques for managing digital content subscription. In various embodiments, techniques are disclosed for facilitating payment for content subscription and on-demand purchase using optical code such as a quick response (QR) code. In some aspects, the techniques implement a system comprising a playback device (e.g., a television, a reception apparatus, a tablet computer, a laptop, a general computer, a wearable device, a set top box [STB]) that is configured to stream various media content such as movies and shows. Generally, the playback device may be configured to receive encoded audio/video signals and decode the signals to be viewed. The media content may be free or provided under a subscription plan offered by a streaming service provider. The subscription plan for the streaming service may be associated with a user account associated with one or more playback devices.

In some aspects, the user account may also be associated with a user device such as a smartphone. The user device may be connected to a communication network operated by a mobile network operator (MNO) and associated with a subscriber account and a cellular plan to receive the telecommunication services. The cellular plan may include benefits or promotions. For example, the cellular plan may include a subscription plan for the streaming service. The subscription plan may be included at no additional cost or at a discounted rate. Accordingly, the user account for the streaming service may be associated with or linked to the subscriber account for the telecommunication services.

The user device may include a native application such as a mobile service provider application that is operated by the MNO. In general, the mobile service provider application is configured to provide tools to manage the subscriber account and the cellular plan. For example, the mobile service provider application may be configured to enable a subscriber to add, remove, upgrade, or downgrade services for the cellular plan. The mobile service provider application may also be configured to enable the subscriber to view and pay bills, request assistance from a customer service representative, and/or so forth.

In some aspects, a subscriber may wish to access premium content that requires additional payment or an upgraded subscription plan. To request a premium content, the subscriber may make a selection to make a one-time payment or upgrade the subscription plan on the playback device. In turn, the playback device may be configured to generate and display an optical code that may be scanned by the user device. The optical code may comprise data related to the requested premium content and a link to a payment portal to pay for the premium content or upgrade the subscription plan to the plan that includes access to the premium content.

Upon scanning and decoding the code, the mobile service provider application may direct a subscriber to a payment portal to facilitate payment transactions. The subscriber may log in to the mobile service provider application using credentials associated with the subscriber account. Accordingly, the billing information associated with the subscriber account may be used to pay for the premium content or the upgraded subscription plan via the payment portal. Once the payment transaction to purchase the premium content or to upgrade the subscription plan is completed, the subscriber receives access to the premium content via the playback device. In some aspects, the mobile service provider application may provide an option to bill later. In this case, the subscriber may select the option to bill later and no payment information is entered or processed once the subscriber is at the payment portal.

The techniques described herein may be implemented in a number of ways. Example implementations are provided below with reference to the following figures.

Example Network Architecture

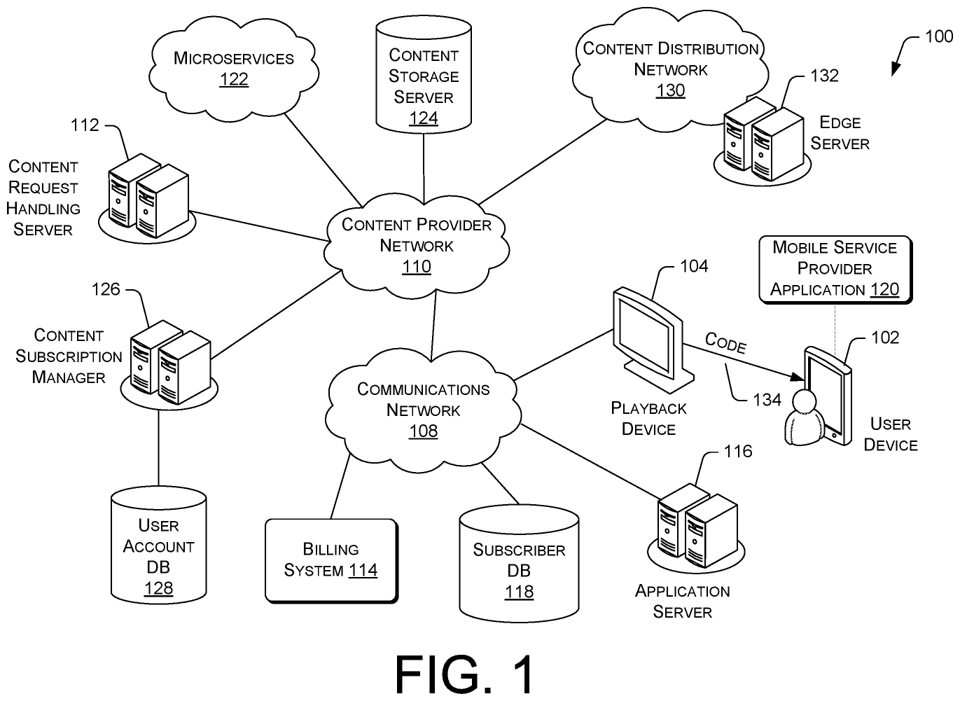

FIG. 1 illustrates example architecture 100 for managing digital content subscription using optical codes. The architecture 100 may include a playback device 104. The playback device 104 may include a smart television, a set top box, a game console, a mobile phone, a tablet computer, general computers, wearable devices (e.g., a head mounted device [HMD]), and other devices connected to a communication network 108 and receive digital content. In some aspects, the playback device 104 may be a digital television receiver that is incorporated in a vehicle or any of the fixed or mobile devices described herein. The playback device 104 provides digital content such as television shows, movies, music, games, and/or so forth.

The playback device 104 is connected to a communication network 108. The communication network 108 can be a cellular network that implements 2G, 3G, 4G, and long-term evolution (LTE), LTE advanced, high-speed data packet access (HSDPA), evolved high-speed packet access (HSPA+), universal mobile telecommunication system (UMTS), code-division multiple access (CDMA), global system for mobile communications (GSM), a local area network (LAN), a wide area network (WAN), and/or a collection of networks (e.g., the Internet).

The playback device 104 receives digital content from a content provider network 110 that may be operated by a streaming services provider. In one aspect, the playback device 104 transmits a request (e.g., a hypertext transfer protocol [HTTP] request) premium content to a content request handling server 126 or another authoritative server of the content provider network 110. In some aspects, the location of the playback device 104 (e.g., an Internet Protocol [IP] address) may be identified, and the request may be routed to the nearest content request handling server 126. In some aspects, the playback device 104 may cache the server information to transmit future requests. The content request handling server 126 may handle the request using various microservices 122. These microservices 122 may be cloud-based services and may comprise a plurality of applications to distribute tasks and resources via an application programming interface (API). For example, the microservices 122 may include an application for handling a request and another application for retrieving the requested content.

The content may be retrieved from a storage location (i.e., content storage servers 124) and passed to a content distribution network 130. The content distribution network 130 may comprise a pool of edge servers 132 for distributing the retrieved content. In some aspects, the content may be cached at one or more edge servers 132. In this way, the most requested content is available on the edge networks of the architecture. In some aspects, the content may be distributed by edge servers 132 closest to the location of the playback device 104 to optimize content delivery.

A subscriber may create an account or sign up to receive services from the streaming service provider. Upon creating an account, various content included in a content subscription plan or free content may be made available and presented via the playback device 104. In the latter case, the content may be presented with paid advertisements or commercials inserted between content segments. In some aspects, the subscription plan may be tiered such that a subscriber can select from a basic, standard, or premium plan, whereby each tiered plan is associated with a price.

The basic plan may be the least expensive, but offer limited content and permit only a single playback device to stream content. The standard plan may allow more content and multiple playback devices to stream content. Finally, the premium content may be the most expensive plan, but provide unlimited content in high definition and allow unlimited playback devices to stream content.

The content subscription plan may be upgraded, downgraded, or canceled based on contractual terms provided by the streaming service provider. In one aspect, the content subscription manager 128 may provide account management functions to oversee content subscription in addition to billing functions, account or content access functions, and/or so forth. Accordingly, the content subscription manager 128 may collect and process various user account information such as user data (e.g., name, address, email address, etc.), usage information (e.g., previously viewed content, recommended content, favorite content, disliked or blocked content, etc.), billing information (e.g., credit card information, billing address, etc.), and/or so forth. The user account information may be stored in an account database 128.

The playback device 104 may be paired with a user device 102. In one aspect, upon powering the playback device 104, the playback device 104 may attempt to pair (e.g., via BLE) with the user device 102. Pairing the playback device 104 and the user device 102 may include receiving at the user device 102, a unique device identifier of the playback device 104. The user device 102 may be a smartphone, mobile device, personal digital assistant (PDA) or other electronic devices having a wireless communication function that is capable of receiving input, processing the input, and generating output data.

The user device 102 may be connected to the communication network 108 utilizing one or more wireless base stations or any other common wireless or wireline network access technologies. The user device 102 may be associated with a subscriber account and a cellular plan to receive telecommunication services from an MNO. The subscriber account may include information related to one or more subscribers, one or more user devices (including the user device 102), and billing information, which may be stored in a subscriber database 118 (e.g., Home Location Register [HLR]/Home Subscriber Server [HSS]).

In some aspects, the cellular plan may include a subscription plan for the streaming service. The subscription plan may be offered at no additional cost or a discounted rate, depending upon embodiments. Accordingly, the user account for the subscription plan and the subscriber account to the cellular plan may be held by the same subscriber and user account, and the subscriber account may share the same account information (e.g., name, address, email address), billing information (e.g., credit card information, billing address, etc.), and/or so forth. In some aspects, the user account for the streaming service may be associated with or linked to the subscriber account for the telecommunication services.

The user device 102 includes a mobile service provider application 120. Generally, the mobile service provider application 120 allows a user to manage the subscriber account and the cellular plan. The mobile service provider application 120 may present a user interface to allow a subscriber to register for login credentials to log in to the application. The login credentials can comprise a username and password. In some aspects, the login credentials may also comprise a unique identifier issued by the MNO. To request a unique identifier or other login credentials, the user may provide information related to a subscriber such as a subscriber account holder's name, phone number, email address, and/or other information. Accordingly, the login credentials for the application may be associated with the subscriber account. In another example, a user may login by responding to a push notification on another previously authenticated user device, which is associated with the user. The subscriber's information may be validated and verified by an application server 116 to ensure that the subscriber is a customer with an existing subscriber account and a current cellular plan. In some aspects, the user device 102 may be a previously authenticated device and a multi-step authentication process may not be necessary.

During the registration process, the subscriber may also request to link the user account and the subscriber account. In this regard, the mobile service provider application 120 may prompt the subscriber to provide information related to the user account associated with the content subscription plan. For example, the subscriber may provide an account number, an account name, email address, and/or other information associated with the user account. In turn, the application server 116 may validate the information related to the user account against the information from the account database 128 and verify that the subscriber is the account holder of the user account. In some aspects, the application server 116 may also determine that the subscriber is authorized to make certain changes to the subscriber account, such as linking the user account and the subscriber account.

The mobile service provider application 120 may provide account management functionalities, billing management functionalities, usage monitoring tools, customer support functionalities, and/or so forth. The subscriber may view and pay a bill or upgrade a cellular plan, or make other purchases (e.g., a la carte services, premium content, etc.) from or through the MNO via the mobile service provider application 120, which may provide a payment portal. In the latter case, the services or products being purchased may be offered by third parties working with the MNO, and the MNO may be an authorized reseller of those services or products. For instance, the MNO may facilitate sales of streaming services in conjunction with or in addition to telecommunication services. Accordingly, the telecommunication services may include the streaming service.

The application server 116 may facilitate billing functions by routing payment transactions from the payment portal to a subscription billing system 114 of the communication network 108. In one example, the subscription billing system 114 may comprise components for encrypting and authenticating the payment transaction. The subscription billing system 114 may also operate with a payment processor to route the transaction to the appropriate banking entities. Once the respective banking entities approve the transaction, the payment gateway communicates the approval of the transaction and the payment is posted.

In some aspects, the billing system 114 may include a promotion manager server that may be configured to select a set of promotions from a database in the communication network 108. The promotions can include credits, account perks, and discounts for various services and products offered by the MNO or by third-party service providers working with the MNO. In some aspects, the application server 116 may query the promotion manager server for promotions or to use the promotions. In one example, a basic plan for streaming services may be included at no additional cost as part of a cellular plan. However, the basic plan may be upgraded to a standard plan or premium content for an additional cost. In some aspects, the upgrade may be available at a discounted rate for the subscriber. In another example, the cellular plan associated with the subscriber account may include credits to a number of on-demand content from streaming services.

The playback device 104 may present a user interface to allow the subscriber to make a selection to access or request premium content that requires additional fees or an upgrade to a content subscription plan. In response to receiving a selection, the playback device 104 transmits the content request to the content request handling server 126 as described above. If the content requires additional fees or an upgrade to a subscription plan, the content request handling server 126 may queue the request until the additional fees are paid or the subscription plan is upgraded.

Additionally, the playback device 104 generates and displays an optical code 134, e.g., a computer-readable code such as a QR code, Aztec code, Maxicode, Data Matrix, and/or various types of barcode such as visual code, spot code, and magneti-code. The optical code 134 may provide information about the requested digital content such as a content identifier of the content and the one-time fee or the cost of the upgrade to the subscription plan that includes the access to the requested content. Additionally, the optical code 134 may include information such as a duration that an upgrade offer is valid, an identifier of the upgrade offer, discount codes, and/or so forth. In some aspects, the optical code 134 may include user-specific information such as a user identifier of the user, an application identifier of the mobile service provider application, user account information, subscriber account information, and/or so forth. The user device 102 may, in turn, scan the optical code 134 using the mobile service provider application 120, which may include optical code reading and decoding functionalities.

Upon scanning and decoding the optical code 134, the mobile service provider application 120 may analyze the information embedded in the optical code 124 to direct a subscriber to a payment portal. For example, the mobile service provider application 120 may compare the application identifier embedded in the optical code 124 to its own encoded application identifier. If the two identifiers match, the mobile service provider application 120 directs a subscriber to a payment portal to submit a payment to access the premium content.

In some embodiments, the optical code 134 may also include a unique session identifier generated by the application server 116, wherein the unique session identifier is associated with the playback device 104. In this way, when the user device 102 initiates an account linking or payment by scanning the optical code 134, the session identifier can be passed to the application server 116. Based on the session identifier, the application server 116 may identify the playback device 104 to deliver the requested premium content.

In some aspects, the optical code 134 may include a uniform resource locator (URL) or a link to a payment portal. In this scenario, the user device may be configured to direct the subscriber to the URL, or the link and the subscriber may directly log in to the payment portal using login credentials associated with the subscriber account. The payment portal may automatically retrieve billing information associated with the subscriber account to pay for the premium content or upgrade the subscription plan. Alternatively, the subscriber may manually input other billing information such as additional credit card information.

Once the payment transaction is completed, the application server 116 notifies the content subscription manager 112 that the premium content or the upgrade is purchased. In turn, the content subscription manager 112 may upgrade the subscription plan that is associated with the user account or make the content accessible to the subscriber. Additionally, the content subscription manager 112 may instruct the content request handling server 126 to process the request to deliver the requested premium content to the playback device 104.

Example Computing Device Components

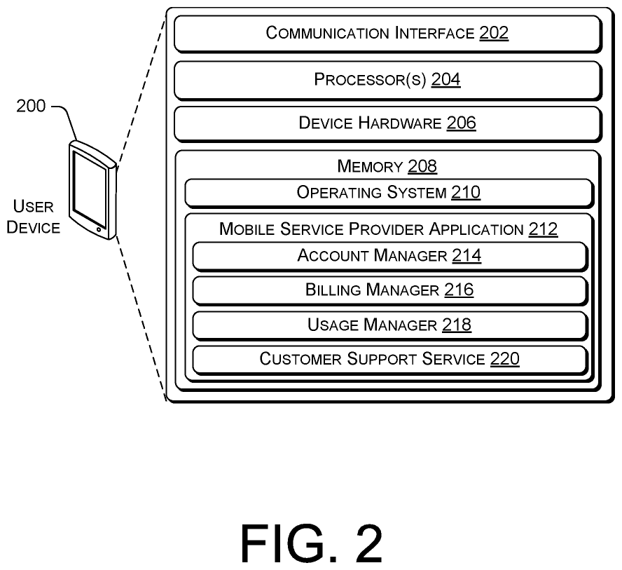

FIG. 2 is a block diagram showing various components of an illustrative computing device, wherein the computing device can comprise a user device 200. It is noted that the user device 200 as described herein can operate with more or fewer of the components shown herein. Additionally, the user device 200 as shown herein or portions thereof can serve as a representation of one or more of the computing devices of the present system.

The user device 200 may include a communication interface 202, one or more processors 204, hardware 206, and memory 208. The communication interface 202 may include wireless and/or wired communication components that enable the user device 200 to transmit data to and receive data from other networked devices. In at least one example, the one or more processor(s) 204 may be a central processing unit(s) (CPU), graphics processing unit(s) (GPU), both a CPU and GPU or any other sort of processing unit(s). Each of the one or more processor(s) 204 may have numerous arithmetic logic units (ALUs) that perform arithmetic and logical operations as well as one or more control units (CUs) that extract instructions and stored content from processor cache memory, and then execute these instructions by calling on the ALUs, as necessary during program execution.

The one or more processor(s) 204 may also be responsible for executing all computer applications stored in the memory, which can be associated with common types of volatile (RAM) and/or nonvolatile (ROM) memory. The hardware 206 may include additional user interface, data communication, or data storage hardware. For example, the user interfaces may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices.

The memory 208 may be implemented using computer-readable media, such as computer storage media. Computer-readable media includes, at least, two types of computer-readable media, namely computer storage media and communications media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms. The memory 208 may also include a firewall. In some embodiments, the firewall may be implemented as hardware 206 in the user device 200.

The processors 204 and the memory 208 of the user device 200 may implement an operating system 210 and a mobile service provider application 212. The operating system 210 may include components that enable the user device 200 to receive and transmit data via various interfaces (e.g., user controls, communication interface, and/or memory input/output devices), as well as process data using the processors 204 to generate output. The operating system 210 may include a presentation component that presents the output (e.g., display the data on an electronic display, store the data in memory, transmit the data to another electronic device, etc.). Additionally, the operating system 210 may include other components that perform various additional functions generally associated with an operating system.

In general, the mobile service provider application 212 allows a subscriber to manage its subscriber account and cellular plan. The mobile service provider application 212 includes an account manager 214, a billing manager 216, a usage monitor 218, and a customer support service 220. The mobile service provider application 212, the account manager 214, the billing manager 216, the usage monitor 218, and the customer support service 220 may include routines, program instructions, objects, and/or data structures that perform particular tasks or implement particular abstract data types. In some aspects, the mobile service provider application 212 may present a graphical user interface of a dashboard for accessing the account manager 214, billing manager 216, usage monitor 218, a customer support service 220, and/or other tools.

The account manager 214 may include one or more instructions, which when executed by the one or more processors 204 direct the user device 200 to perform operations related to upgrading, downgrading, or canceling the cellular plan. The account manager 214 may also add or remove additional devices or users registered under the subscriber account. In some aspects, the account manager 214 may provide access management and security by managing login credentials for the subscriber account.

Additionally, the account manager 214 may add or remove services and products under the subscriber account. The services may include streaming services, television services, data services including text messaging services (SMS) and photo or other multimedia messaging services (MMS). The services and products may be provided by an MNO or provided by third parties working with the MNO such as stream service providers and the MNO may be an authorized reseller of those services or products. The services may be offered via a la carte pricing options. For example, services may be offered on a pay-as-you-go basis for a flat rate per each instance, or services may be purchased as a package for a fixed monthly fee. In one aspect, the account manager 214 may add a streaming service to access to premium content from a streaming service provider. Additionally, the account manager 214 may upgrade the subscription plan offered by a streaming service provider.

The billing manager 216 may include one or more instructions, which when executed by the one or more processors 204 direct the user device 200 to perform operations related to updating, adding, or removing billing information. The billing manager 216 may also set up automatic payments, schedule one-time payments, cancel payments, submit payment queries, and/or so forth. In some aspects, the billing manager 216 may detect a receipt of an invoice from a billing system and provide a notification to pay the invoice at a predetermined date (e.g., due date) using the preferred payment method as specified in the billing information.

The billing manager 216 may also be configured to provide a payment portal. The payment portal may comprise a graphical user interface to receive one or more selection inputs to activate and determine payment settings associated with one or more payment accounts, amounts to be paid, one or more respective payment dates associated with each of the amounts to be paid, and/or so forth. The billing manager 216 may also apply promotions and other eligible benefits to the subscriber account.

The usage monitor 218 may include one or more instructions, which when executed by the one or more processors 204 direct the user device 200 to perform operations related to reviewing usage. The usage monitor 218 may be configured to calculate usage information (e.g., data usage) for individual user devices and users registered under the subscriber account. The usage monitor 218 may also be configured to limit usage for one or more user devices and users registered under the subscriber account. The usage monitor 218 may also be configured to set up notifications if the usage exceeds a predetermined threshold.

The customer support service 220 may interface with a knowledge base where subscribers can access answers to common questions, a discussion forum or a social platform for interacting with other subscribers or customer support technicians, a live chat tool, a messaging tool, a trouble ticket generation tool, and/or so forth. In some aspects, the user device 200 may directly communicate with the customer support terminal via voice over Internet protocol (VoIP), conversation interfaces (CI), chat user interfaces (UI), and/or so forth.

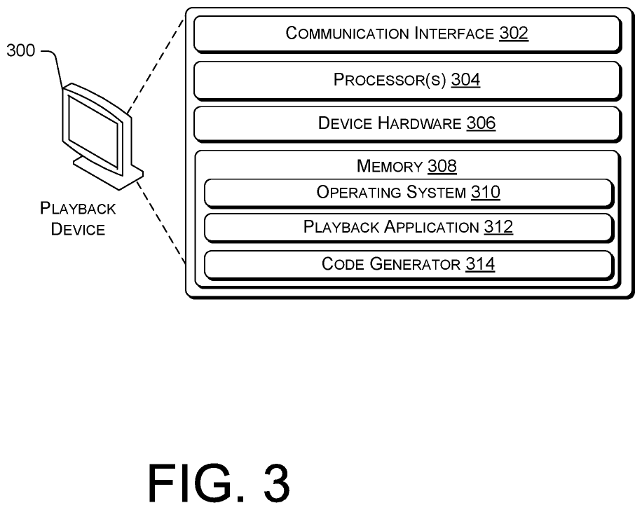

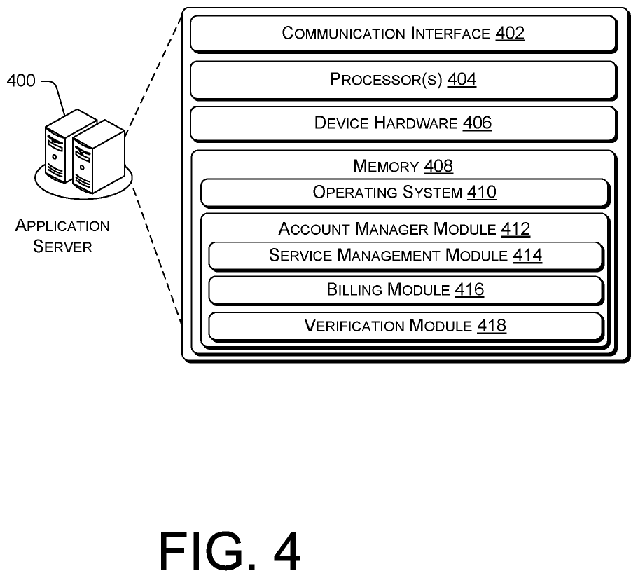

FIG. 3 is a block diagram showing various components of an illustrative computing device, wherein the computing device can comprise a playback device 300 such as a television, which is configured to access and present one or more premium content. It is noted that the playback device 300 as described herein can operate with more or fewer of the components shown herein. Additionally, the playback device 300 as shown herein or portions thereof can serve as a representation of one or more of the computing devices of the present system.

The playback device 300 may include a communication interface 302, one or more processors 304, hardware 306, and memory 308. The communication interface 302 may include wireless and/or wired communication components that enable the playback device 300 to transmit data to and receive data from other networked devices. For example, the communication interface 302 may include receiver circuitry that is configured to receive a data stream (e.g., a broadcast stream) from one or more content providers and processing circuitry that is configured to perform various functions of the playback device 300.

In at least one example, the one or more processor(s) 304 may be a central processing unit(s) (CPU), graphics processing unit(s) (GPU), both a CPU and GPU or any other sort of processing unit(s). Each of the one or more processor(s) 304 may have numerous arithmetic logic units (ALUs) that perform arithmetic and logical operations as well as one or more control units (CUs) that extract instructions and stored content from processor cache memory, and then execute these instructions by calling on the ALUs, as necessary during program execution.

The one or more processor(s) 304 may also be responsible for executing all computer applications stored in the memory, which can be associated with common types of volatile (RAM) and/or nonvolatile (ROM) memory. The hardware 306 may include additional user interface, data communication, or data storage hardware. For example, the user interfaces may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices.

The memory 308 may be implemented using computer-readable media, such as computer storage media. Computer-readable media includes, at least, two types of computer-readable media, namely computer storage media and communications media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms. The memory 308 may also include a firewall. In some embodiments, the firewall may be implemented as hardware 306 in the playback device 300.

The processors 304 and the memory 308 of the playback device 300 may implement an operating system 310, a playback application 312, and a code generator 314. The operating system 310 may include components that enable the playback device 300 to receive and transmit data via various interfaces (e.g., user controls, communication interface, and/or memory input/output devices), as well as process data using the processors 304 to generate output. The operating system 310 may include a presentation component that presents the output (e.g., display the data on an electronic display, store the data in memory, transmit the data to another electronic device, etc.). Additionally, the operating system 310 may include other components that perform various additional functions generally associated with an operating system.

The playback application 312 and the code generator 314 may include routines, program instructions, objects, and/or data structures that perform particular tasks or implement particular abstract data types. For example, the playback application 312 may include one or more instructions, which when executed by the one or more processors 304 direct the playback device 300 to perform operations related to support streaming services. For instance, the playback application 312 may present a graphical user interface for providing a menu of available digital content and receiving a selection for the requested content. Additionally, the playback application 312 may recommend content based on a user's viewing history, favorite content, and/or blocked content. In some aspects, the playback application 312 may enable multiple users to create individual profiles. In this way, different content may be recommended for different users based on respective users' viewing history. The playback application 312 may be pre-installed in the playback device 300 or downloaded.

The code generator 314 may include one or more instructions, which when executed by the one or more processors 304 direct the playback device 300 to perform operations related to generating any optical code (e.g., a machine-readable code, a QR code, bar code, etc.) that can be displayed on the playback device 300. The optical code may comprise information related to the requested content, subscriber account information, user account information, and/or so forth.

FIG. 4 is a block diagram showing various components of an illustrative computing device, wherein the computing device can comprise an application server 400. It is noted that the application server 400 as described herein can operate with more or fewer of the components shown herein. Additionally, the application server 400 as shown herein or portions thereof can serve as a representation of one or more of the computing devices of the present system.

The application server 400 may include general-purpose computers, such as desktop computers, tablet computers, laptop computers, servers (e.g., on-premise servers), or other electronic devices that are capable of receiving input, processing the input, and generating output data. In one aspect, the application server 400 may be operated by a mobile network operator (MNO) or a third-party entity that is working with the MNO. The application server 400 may store data in a distributed storage system, in which data may be stored for long periods and replicated to guarantee reliability. Additionally, in a networked deployment, new computing nodes and servers may be added. The computing nodes and servers may be physical machines that may be grouped and presented as a single computing system or in the form of virtual machines, such as virtual engines (VE) and virtual private servers (VPS).

The application server 400 may include a communication interface 402, one or more processors 404, hardware 406, and memory 408. The communication interface 402 may include wireless and/or wired communication components that enable the application server 400 to transmit data to and receive data from other networked devices. For example, the communication interface 402 may include receiver circuitry that is configured to receive a data stream (e.g., a broadcast stream) from one or more content providers and processing circuitry that is configured to perform various functions of the application server 400.

In at least one example, the one or more processor(s) 404 may be a central processing unit(s) (CPU), graphics processing unit(s) (GPU), both a CPU and GPU or any other sort of processing unit(s). Each of the one or more processor(s) 404 may have numerous arithmetic logic units (ALUs) that perform arithmetic and logical operations as well as one or more control units (CUs) that extract instructions and stored content from processor cache memory, and then execute these instructions by calling on the ALUs, as necessary during program execution.

The one or more processor(s) 404 may also be responsible for executing all computer applications stored in the memory, which can be associated with common types of volatile (RAM) and/or nonvolatile (ROM) memory. The hardware 406 may include additional user interface, data communication, or data storage hardware. For example, the user interfaces may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices.

The memory 408 may be implemented using computer-readable media, such as computer storage media. Computer-readable media includes, at least, two types of computer-readable media, namely computer storage media and communications media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms. The memory 408 may also include a firewall. In some embodiments, the firewall may be implemented as hardware 406 in the application server 400.

The processors 404 and the memory 408 of the application server 400 may implement an operating system 410 and an account manager module 412. The operating system 410 may include components that enable the application server 400 to receive and transmit data via various interfaces (e.g., user controls, communication interface, and/or memory input/output devices), as well as process data using the processors 404 to generate output. The operating system 410 may include a presentation component that presents the output (e.g., display the data on an electronic display, store the data in memory, transmit the data to another electronic device, etc.). Additionally, the operating system 410 may include other components that perform various additional functions generally associated with an operating system.

The account manager module 412 may include components such as a services management module 414, billing module 416, and verification module 418. The account manager module 412, the services management module 414, the billing module 416, and verification module 418 may include routines, program instructions, objects, and/or data structures that perform particular tasks or implement particular abstract data types. For example, the account manager module 412 may include one or more instructions, which when executed by the one or more processors 404 direct the application server 400 to perform operations related to managing the subscriber account and the cellular plan. In some aspects, the account manager module 412 may communicate with a policy database in order to manage the subscriber account and the cellular plan based at least on one or more policies of an MNO.

The services management module 414 may add additional subscribers and/or devices under a subscriber account. In another example, the services management module 414 may add or remove services to a cellular plan. In this regard, the services management module 414 may increase or decrease data, voice, or messaging allowance. The services management module 414 may also be configured to upgrade, downgrade, or cancel the cellular plan, which in turn may add or remove one or more services such as streaming services. The services may be provided by an MNO or a third-party service provider working with the MNO. For instance, upgrading the cellular plan may allow the subscriber to become eligible for a premium content subscription plan, which provides access to premium content. Conversely, downgrading the cellular plan may also downgrade the content subscription plan, which may limit access to premium content. In some aspects, the service management module 414 may also be configured to add a la carte services or limited services to a user account. For example, the service management module 414 may make available premium content (e.g., movie) for a single viewing for a limited time.

To ensure that appropriate services are available to permitted devices and subscribers associated with a subscriber account, the verification module 418 may perform verification functions. For example, in response to receiving a request to link a user account and a subscriber account from a user device, the verification module 418 may verify that the subscriber of the subscriber account is also the account holder of the user account. In this regard, the verification module 418 may receive information related to the user account from the user device. In turn, the verification module 418 may query the account database of the content provider network for information related to the user account. In response to receiving the user account information from the account database, the verification module 418 may validate the user account information from the user against the user account information from the account database 128. In this way, the verification module 418 may verify that the subscriber is the account holder of the user account. In some aspects, the verification module 418 may also determine that the subscriber is authorized to make certain changes to the subscriber account such as linking the user account and the subscriber account. For example, the verification module 418 may determine that the subscriber is the primary account holder of the subscriber account and the user account. To determine that the subscriber is the authorized user, the verification module 418 may request additional credentials such as PIN and one-time or dynamic password. The verification module 128 may also implement numerous authentication methods such as multi-factor authentication (MFA), depending upon embodiments

In response to upgrading, downgrading, or canceling the cellular plan or adding or removing services, the billing module 416 may issue a bill from a billing system of the communication network or apply a credit to the subscriber account. In some aspects, the billing module 416 may query the promotion manager server for promotions or request to use the promotions. In response, the promotion manager server may determine whether the subscriber account is eligible to receive a promotion based on one or more eligibility criteria. The eligibility criteria may include whether the subscriber account is associated with a certain cellular plan, whether the subscriber account is associated with certain user devices, and/or so forth. If the subscriber account is associated with a certain cellular plan, then the subscriber account may receive a credit or discount towards receiving access to premium content from the streaming service.

In some aspects, the billing module 416 may route payment transactions from the payment portal to the billing system, which may, in turn, communicate with a payment processor and a payment gateway. Once the cellular plan is changed (i.e., upgraded, downgraded, or canceled), the billing module 416 may notify the content subscription manager to make the appropriate changes to the subscription plan associated with the user account. For example, if the cellular plan is upgraded, the content subscription manager may upgrade the subscription plan that is associated with the user account or make the content accessible to the subscriber and instruct the content request handling server to process the request to deliver the requested content to the playback device. Similarly, if services are added or removed from a cellular plan, the billing module 416 may notify the content subscription manager to process the request for premium content accordingly. For example, if a one-time purchase is made to access the premium content, the content subscription manager may instruct the content request handling server to process the request to deliver the requested content to the playback device

### Example Processes

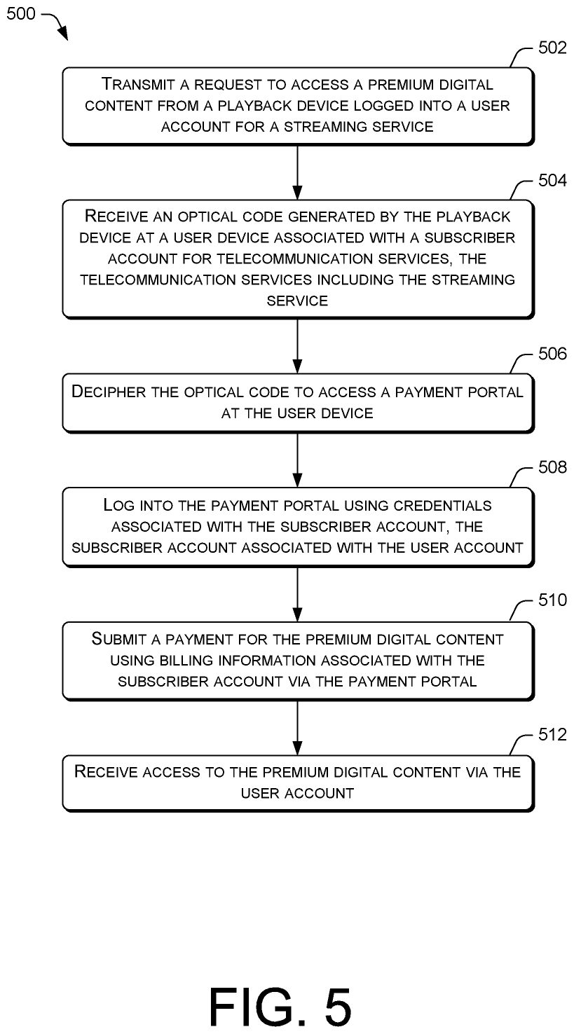

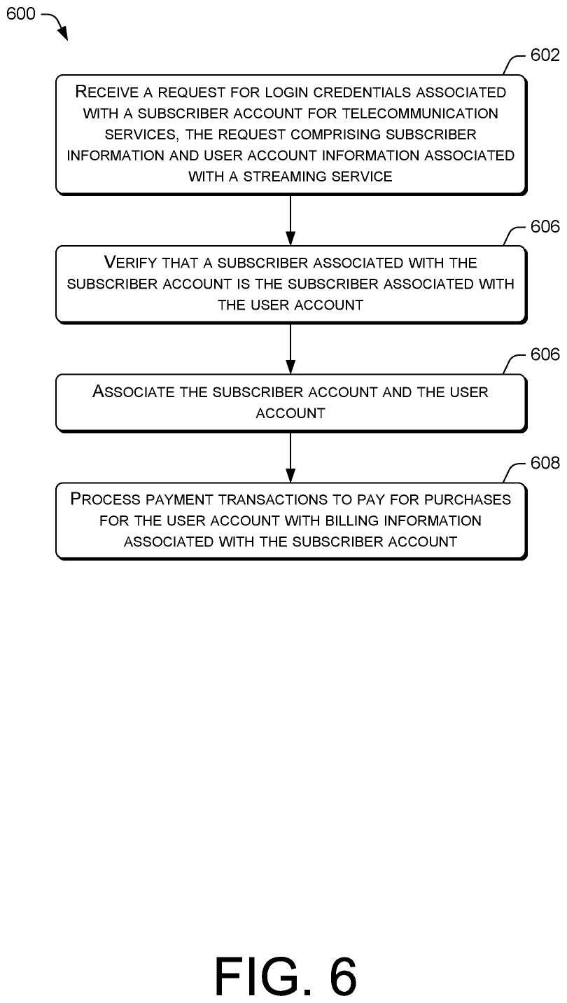

FIGS. 5-6 presents an illustrative process 500-600 for managing subscriptions for digital content. The processes 500-600 are illustrated as a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes 500-600 are described with reference to FIGS. 1-4.

FIG. 5 is a flow diagram of an example process 500 for requesting digital content subscription management. At block 502, a user device transmits a request to access premium content from a playback device logged into a user account for a streaming service. The user account may be associated with a subscription plan for the streaming service. At block 504, the user device receives an optical code generated by the playback device. The user device is associated with a subscriber account for telecommunication services. Accordingly, the subscriber account is associated with a cellular plan. The subscriber account may be eligible for various benefits or promotions. Accordingly, the cellular plan associated with the subscriber account may include a subscription plan to the streaming service and the telecommunication services may include the streaming service. The telecommunication services and the streaming service may be provided by the same service provider or different providers working together.

At block 506, the user device deciphers the optical code to access a payment portal at the user device. The user device may scan and decipher the optical code using a mobile application such as a mobile service provider application residing locally on the user device. In some aspects, the application may provide a payment portal. Alternatively, the payment portal may be provided on a website or a web application. At block 508, the user device provides a user interface to log in to the payment portal using credentials associated with the subscriber account, wherein the subscriber account is associated with the user account. At block 510, the user device may submit a payment for the premium content using billing information that is associated with the subscriber account via the payment portal. The payment transaction may be routed to a billing system. Once the payment transaction is approved and completed, the user device receives access to the premium content via the user account. The premium content may be presented on the playback device. Alternatively, the user device may select an option at the payment portal to be billed at a different time. If the user selects the option to defer payment, fees associated with accessing the premium content may be billed to the subscriber account and made payable at a later time. Thus, the user device may receive access to the premium content via the user account and the premium content may be presented on the playback device before the payment is made.

FIG. 6 is a flow diagram of an example process 600 for associating a user account and a subscriber account. At block 602, an application server receives a request for login credentials for a mobile application, wherein the login credentials are associated with a subscriber account for telecommunication services. The request may comprise subscriber information and user account information associated with a streaming service. The telecommunication services and the streaming service may be provided by the same service provider or different service providers. In the latter case, one of the service providers may be an authorized reseller of the services and/or products of the other service provider.

At block 604, the server verifies that a subscriber associated with the subscriber account is the subscriber associated with the user account. In some aspects, the server may verify that the requesting subscriber is an authorized subscriber (e.g., a primary account holder). In one example, the server may prompt the subscriber to provide credentials (e.g., username and password) for the user account. At block 606, the server associates the subscriber account and the user account. Said another way, the server may link the subscriber account to the user account, wherein the subscriber account is the account of the subscriber of the MNO and the user account is the account of the subscriber of the streaming service provider. At block 608, the server processes payment transactions to pay for purchases for the user account with billing information associated with the subscriber account. The billing information may include credit card information for credit card payments, bank account information for direct deposit or electronic fund transfer, billing address, preferred payment methods, and/or so forth.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. One or more non-transitory computer-readable media storing computer-executable instructions that upon execution cause one or more processors to perform acts comprising:
transmitting a request to access premium content from a playback device logged into a user account for a streaming service;
receiving an optical code generated by the playback device at a user device associated with a subscriber account for telecommunication services;
deciphering the optical code to access a payment portal at the user device;
logging into the payment portal using credentials associated with the subscriber account, the subscriber account associated with the user account;
submitting a payment for the premium content using billing information associated with the subscriber account via the payment portal; and
receiving access to the premium content via the user account.

2. The one or more non-transitory computer-readable media of claim 1, wherein the subscriber account is linked to the user account.

3. The one or more non-transitory computer-readable media of claim 1, wherein the acts further comprise:
receiving additional credentials associated with the user account; and
verifying, based at least on the additional credentials, that a subscriber associated with the subscriber account is the subscriber associated with the user account.

4. The one or more non-transitory computer-readable media of claim 1, wherein the subscriber plan is associated with a cellular plan for the telecommunication services, the cellular plan including a subscription plan for the streaming service.

5. The one or more non-transitory computer-readable media of claim 4, wherein the user account is associated with the subscription plan.

6. The one or more non-transitory computer-readable media of claim 4, wherein the premium content is not included in the subscription plan.

7. The one or more non-transitory computer-readable media of claim 1, wherein the telecommunication services and the streaming service are provided by different service providers.

8. The one or more non-transitory computer-readable media of claim 1, wherein a service provider for the telecommunication services is an authorized reseller of the streaming service.

9. A computer-implemented method, comprising:
transmitting a request to access premium content from a playback device logged into a user account for a streaming service;
receiving an optical code generated by the playback device at a user device associated with a subscriber account for telecommunication services;
deciphering the optical code to access a payment portal at the user device;
logging into the payment portal using credentials associated with the subscriber account, the subscriber account associated with the user account;
submitting a payment for the premium content using billing information associated with the subscriber account via the payment portal; and
receiving access to the premium content via the user account.

10. The computer-implemented method of claim 9, wherein the subscriber account is linked to the user account.

11. The computer-implemented method of claim 9, further comprising:
receiving additional credentials associated with the user account; and
verifying, based at least on the additional credentials, that a subscriber associated with the subscriber account is the subscriber associated with the user account.

12. The computer-implemented method of claim 9, wherein the subscriber plan is associated with a cellular plan for the telecommunication services, the cellular plan including a subscription plan for the streaming service.

13. The computer-implemented method of claim 12, wherein the user account is associated with the subscription plan.

14. The computer-implemented method of claim 12, wherein the premium content is not included in the subscription plan.

15. The computer-implemented method of claim 12, further comprising:
transmitting a request to upgrade the subscription plan, wherein an upgraded subscription plan includes the access to the premium content;
submitting an additional payment for the upgraded subscription plan using the billing information associated with the subscriber account via the payment portal; and
accessing the upgraded subscription plan via the user account.

16. The computer-implemented method of claim 9, wherein the optical code comprises a link to the payment portal.

17. A system, comprising:
one or more non-transitory storage mediums configured to provide stored computer-readable instructions, the one or more non-transitory storage mediums coupled to one or more processors, the one or more processors configured to execute the computer-readable instructions to cause the one or more processors to:
transmit a request to access premium content from a playback device logged into a user account for a streaming service;
receive an optical code generated by the playback device at a user device associated with a subscriber account for telecommunication services, the telecommunication services including the streaming service;
decipher the optical code to access a payment portal at the user device;
log in to the payment portal using credentials associated with the subscriber account, the subscriber account associated with the user account;
submit a payment for the premium content using billing information associated with the subscriber account via the payment portal; and
receive access to the premium content via the user account.

18. The system of claim 17, wherein the one or more processor is further configured to:
receive additional credentials associated with the user account; and
verify, based at least on the additional credentials, that a subscriber associated with the subscriber account is the subscriber associated with the user account.

19. The system of claim 17, wherein the subscriber plan is associated with a cellular plan for the telecommunication services, the cellular plan including a subscription plan for the streaming service.

20. The system of claim 17, wherein the optical code comprises at least one of QR code, Aztec code, Maxicode, Data Matrix, visual code, spot code, and magneti-code.
